(19) United States
(12) Patent Application Publication
(10) Pub. No.: US 2012/0190000 A1
(43) Pub. Date: Jul. 26, 2012

(54) Learning Asset Technology Integration Support Tool

(76) Inventors: Nada Dabbagh, Fairfax, VA (US); Kevin Clark, Arlington, VA (US)

(21) Appl. No.: 13/149,123

(22) Filed: May 31, 2011

Related U.S. Application Data
(60) Provisional application No. 61/349,608, filed on May 28, 2010.

(51) Int. Cl. G09B 7/00

(52) U.S. Cl. 434/362

(57) ABSTRACT

A computer implemented process for making a pedagogically informed selection of a learning technology for a learning objective. Predetermined learning outcomes taxonomy level(s) for learning objective(s) are presented. Predetermined instructional strategy(ies) aligned with a selected learning outcomes taxonomy level chosen from the Predetermined learning outcomes taxonomy level(s) are presented. Predetermined learning technolog(ies) chosen from the predetermined instructional strategy(ies) are presented.

### CROSS-REFERENCE TO RELATED APPLICATIONS

This application claims the benefit of U.S. Provisional Application No. 61/349,608, filed May 28, 2010, entitled “Learning Asset Technology Integration Support Tool,” which is hereby incorporated by reference in its entirety.

### STATEMENT REGARDING FEDERALLY SPONSORED RESEARCH OR DEVELOPMENT

This invention was made with government support under Grant Number W91CRB-09-C-0095 awarded by the US Department of Defense, Army RDE Command. The government has certain rights in the invention.

### BRIEF DESCRIPTION OF THE SEVERAL VIEWS OF THE DRAWINGS

FIG. 1 is a block diagram of an aspect of an embodiment of the present invention.

FIG. 2 is an illustration of an example home page as per an aspect of an embodiment of the present invention.

FIG. 3 is an illustration of an example Explore Research home page as per an aspect of an embodiment of the present invention.

FIG. 4 is an example flow diagram of an explore research component as per an aspect of an embodiment of the present invention.

FIG. 5 is an illustration of an example technology report as per an aspect of an embodiment of the present invention.

FIG. 6 is an illustration of an example Select Technology home page as per an aspect of an embodiment of the present invention.

FIG. 7 is an example flow diagram of a Select Technology component as per an aspect of an embodiment of the present invention.

FIG. 8 is an example flow diagram of a Select Technology component as per an aspect of an embodiment of the present invention.

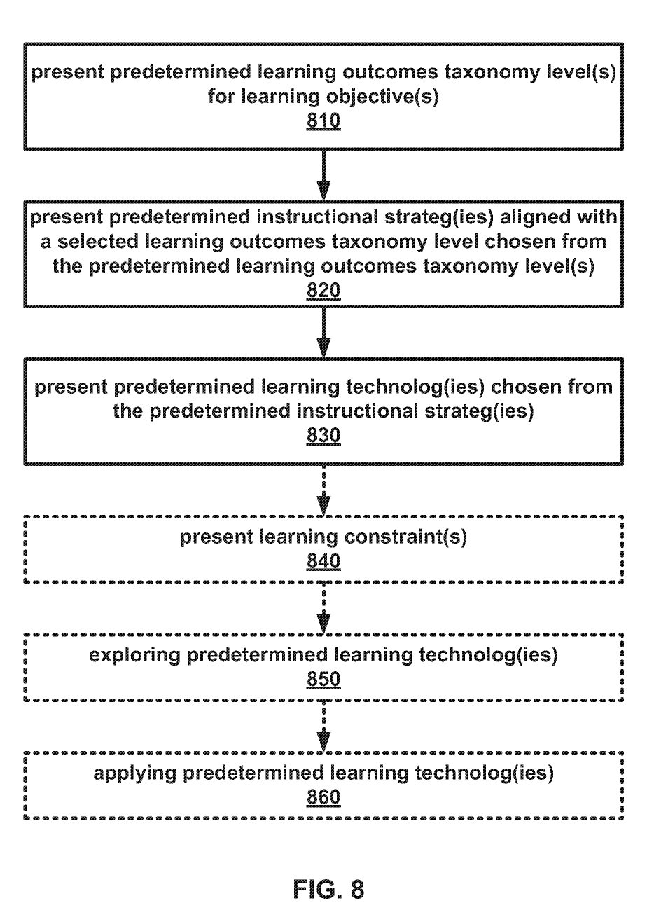

FIG. 9 is an example flow diagram illustrating the addition of materials to LATIST as per an aspect of an embodiment of the present invention.

FIG. 10 is an illustration of an example Select Technology home page as per an aspect of an embodiment of the present invention.

FIG. 11 is an example flow diagram of an Apply Technology component as per an aspect of an embodiment of the present invention.

FIG. 12 is a table showing example relationships between Bloom's learning level to instructional strategy to technology.

FIG. 13 is an example resource attributes table as per an aspect of an embodiment of the present invention.

### DETAILED DESCRIPTION OF EMBODIMENTS

Embodiments of the Learning Asset Technology Integration Support Tool (LATIST) provides users with a framework to make pedagogically informed technology choices. Components in embodiments may include, but are not limited to: an explore research component, a select technology component, and an apply technology component. Embodiments allow users such as teacher(s) and/or trainer(s) to choose distance education tools that are suited to various real world constraints.

Embodiments of the Explore Research component enable user(s) to research advantages, disadvantages and best practices of existing learning technologies such as PodCasts, Blogs, Wikis, Games and Mobile Technologies.

Embodiments of the Select Best Technology component enable user(s) to further explore technologies based upon specific constraints. This function may allow user(s) to select appropriate technologies based on specific learning objectives and instructional strategies, and to evaluate their feasibility based on factors such as budget and bandwidth.

Embodiments of the Apply Technology component may provide a technology demonstration and practice capability, as well as an example of technology(ies) in use in government and other settings. E

Embodiments of the Learning Asset Technology Integration Support Tool (LATIST) are research-driven processes and methods for incorporating Advanced Learning Technologies (ALT) in a pedagogically sound manner within learning assets. Embodiments of LATIST may enable user(s) to: (1) explore what the research says about a technology such as advantages and disadvantages; (2) select a best technology for user conditions such as learning objectives and bandwidth constraints; and (3) review and learn how to apply a selected technology. Embodiments of LATIST may be implemented as an electronic performance support tool.

Embodiments may use an open-source content management system with a back-end database to house and manage LATIST content. According to embodiments, LATIST may dynamically load information based on user needs to support selecting a best technology and providing a searchable repository of the research related and how-to apply information.

Embodiments may use Advanced Learning Technologies (ALT) to enhance learning assets through processes and research-based methods for incorporating pedagogically sound ALT design and delivery tools within a users available learning modalities. Embodiments may be implemented as an online support tool solution to aid decision making regarding technologies to integrate into learning courses while providing research and tutorials on pedagogically sound use of such technologies.

Potential user(s) of embodiments may include, but are not limited to: Educational Directors, Performance Learning Directors, Course Managers, Instructional Systems Designers, Knowledge Project Officers, and Technology Experts.

Embodiments may include multiple components to meet the specific needs of various user(s), regardless of their role in the ALT integration process. Explore Research: This component may present research on previously defined ALT of social media, virtual worlds/games and simulations, mobile technologies and the like. Pedagogically appropriate usage, best practices, and recommendations may be included. Select Best Technology: This component may present ALT research findings narrowed to satisfy needs identified through interview and survey responses and on course levels and identified learning objectives. Findings may be presented to facilitate ALT integration decision-making by user(s). Apply Technology: This component may examine specific learning assets selected and showcase potential uses of ALT, including information and training on how and why particular technologies were chosen and integrated.

Embodiments of LATIST may be implemented as an integrated electronic environment that is available to and accessible by user(s) and is structured to provide immediate, individualized on-line access to a range of information including, but not limited to: software, guidance, advice and assistance, data, images, tools, and assessment and monitoring. In other words, embodiments of the present invention may be used to help user(s) make informed decisions about ALT and to find research and resources to assist in integrating technology into learning assets.

Specifically, embodiments may facilitate decision making by providing (a) a pedagogically driven decision support tool, (b) a repository of research on technology use in government, business, and education, and (c) access to information on how to integrate technology within learning assets. LATIST may also be used as a tool to raise awareness of technology options and to provide a reference tool for making technology decisions. As research and resources on ALT are constantly growing and evolving, embodiments of LATIST may be configured to be scalable by enabling user(s)s interactions by embedding capabilities such as tagging, saving, sharing, and uploading within the tool.

According to embodiments, various task analysis methodologies may be utilized such as the Task Knowledge Structure (TKS) method and the Information Processing Analysis (IPA) method. TKS is an activity-based task analysis method focusing on how the interaction of human activity occurs within an environmental context. Embodiments of TKS may also be a goal-oriented method that draws on essential use cases to analyze tasks that will help achieve the specific user's purposes identified during role modeling. The goals identified during a TKS task analysis may be performed simultaneously. For example, in according to some embodiments, user(s) may navigate from a certain technology in an Explore Research component directly to that same technology in an Apply Technology component. Access to Select Best Technology may be available from other parts of embodiments. The interface may provide user(s) with horizontal access to information rather than in a pre-determined hierarchical sequence.

IPA may be used to create an idealized model. Taking into account course learning objectives and other identified factors, this task analysis method may enable decisions regarding learning asset creation. Embodiments of the IPA method may analyze how individuals perform tasks and how they evaluate multiple factors to make decisions. The idealized decision-making process of embodiments may serve as a model for user(s) to recognize the relationship between pedagogy and appropriate integration of ALT within learning assets.

Through task modeling, tasks necessary to meet previously identified user needs such as search for information, choose a technology, and apply the technology may be implemented. From these tasks, objectives that user(s) of the framework may accomplish may be defined.

Embodiments of the present invention may identify and use taxonomies of learning outcomes. Taxonomies may provide a way to classify tasks and align them with appropriate content, instructional strategies, and evaluations. Content for embodiments may be developed based on what user(s) need in order to meet desired outcomes identified during task modeling. Two examples of taxonomies to align user needs, tasks, and outcomes with content are: the Jonassen and Tessmer taxonomy and Merrill's component display theory taxonomy.

The Jonassen and Tessmer taxonomy is a classification tool that takes into account not only traditional behavioral outcomes, but also cognitive, metacognitive, and motivational outcomes. A potential user(s) may need to gain knowledge about a variety of technologies. The Jonassen and Tessmer taxonomy focuses on extending a user's knowledge. Metacognitive outcomes may be addresses as user choices are made and as user(s) make inferences based upon factors not explicit, such as personal experience. Jonassen and Tessmer recognize that multiple outcomes are possible and that multiple measures may be used to assess those outcomes. This acceptance of multiplicity may allow an instructional designer to consider multiple entry points, multiple user needs, and multiple exit points. Technological innovation is specifically noted in this taxonomy, which may make it a choice for the technology-driven content and delivery model.

Merrill's taxonomy is based on component display theory where tasks and content are each considered separately. This taxonomy may allow examination of user tasks and content desired by the user. The Merrill taxonomy may provide further alignment of user and system needs with content. Adoption of this taxonomy may allow the conceptualization of proposed content as individual learning components. Merrill defined tasks such as identify, interpret, and execute may be suited to some types of tasks and content.

Embodiments may be utilized as a performance support and decision making tool. Some information may need to be explicit, accessible, and usable.

Several learning objectives may be defined to guide the design and development of embodiments. Embodiments may include visual representations of the desired navigation and functionality. Since some content may be dynamically loaded based on user input, a backend database may be required to support certain features. Logical data element relationships may be provided for the databases.

Embodiments may be implemented as an online performance support tool. The content and task analysis may identify subtasks associated with tasks (such as explore, select, and apply) as well as system response requirements. These subtasks may be categorized to identify the type of performance support and training necessary to meet a user(s) needs and system responses. These tasks may serve as the basis for the development of learning objectives. User(s) of some embodiments may be able to: (1) explore and interpret what the research says about learning technologies; (2) compare advantages and disadvantages of using technologies in teaching and learning contexts; (3) examine best practices of technology use in a variety of teaching and learning contexts; (4) select an appropriate instructional strategy and learning technology given a specific learning outcome; (4) select an appropriate technology for a learning asset given a specific factor or a group of factors; (5) learn how technologies are implemented in educational contexts; (6) see real world examples of educational technology used in government, corporations, and higher education; (7) practice creating technologies to use in your learning assets; or the like.

Some embodiments may include an Explore Research component that may be configured to function as a research-based body of knowledge on the subject of ALT. Examples of broad categories of ALT that may be addressed in an Explore Research component include: (1) Social Media, (2) Virtual Worlds/Games and Simulations, (3) Mobile Technologies, or the like. User(s) may enter an Explore Research component to access research-based information related to ALT categories. Some user(s) may be satisfied with a brief summary such as reviewing an overview, advantages, disadvantages, and best practices of a specific ALT or a category of ALT. Other user(s) might want to pursue more in-depth research by reviewing the available literature of that technology perhaps focusing on articles that have been highly rated by their peers. User(s) may be able to move within different sections or views of the Explore Research component and between components such as the Explore Research, Select Best Technology, and Apply Technology components. While in the Explore Research component, user(s) may be able to print, share, add, upload, mark their favorites, and rate resources, it is envisioned that some embodiments may include recommendations for other resources for user(s) to review based on tagging or other such classification type metadata.

Some embodiments may include a Select Best Technology component configured to guide user(s) to make informed decision about which technologies to integrate into learning assets. This component may include subcomponents such as: a Decision Aide and/or a Factors Grid. Through the Decision Aide, users may select a learning objective level that matches the learning objective for an identified course or learning asset. The Decision Aide may respond by providing a list of potential instructional strategies for this learning objective. User(s) may be prompted to select an instructional strategy from a list. The system may return a “best technology” to user(s) that may enhance learning for that specific learning objective. The term “best technology” refers to a technology that may appear to satisfy requirements of a specific learning technology from among one or more predetermined learning technolog(ies). In some embodiments, a “best technology” may refer to more than one technology. According to some embodiments, a Factors Grid may allow user(s) to evaluate technologies based upon criteria specific to constraints such as, but not limited to: bandwidth, information stability, development cost, maintenance cost, speed to market, or the like. By utilizing both the Decision Aide and Factors Grid, user(s) may be able to evaluate technologies in a pedagogically sound manner while taking specific criteria into consideration.

Some embodiments may include an Apply Technology component configured to enable user(s) to interact with several technologies via tutorials prior to the integration of these technologies into a learning environment. The Apply Technology component may provide user(s) with the opportunity to learn how to apply a specific technology by providing options such as learn how to implement the technology; view real world examples of use in contexts such as a business, military, and educational contexts; and gain hands-on practice. User(s) may access information using capabilities such as, but not limited to: embedded or hyperlinked videos, text documents, URLs to external websites, or the like. Information provided in an Apply Technology component may allow user(s) to incorporate selected technolog(ies) suitable for a learning asset.

In addition to the features associated with each of the three components discussed, embodiments may provide global features. For example, user(s) may be able to access the Explore Research and Apply Technology content based on a selected technology. According to embodiments, user(s) may also be able to log in to add personal features such as, but not limited to: rating articles, uploading content, taking personal notes, or the like. A search function may also be included to locate resources based on filtering agents such, but not limited to: date, title, keyword, author, or the like. A dictionary may be implemented in embodiments to provide quick reference on what a technology is as well as define implementation factors. A Help feature may be implemented in some embodiments to target technical issues related to system features such as uploading documents.

Functionality for some embodiments may be described from both a system and user perspective. From a system perspective, the design functionality may focus on hardware and software capabilities in order to provide a tool that support desired objectives, navigation, layout, or the like. Functionality for some embodiments may support access in an anytime, anyplace environment, including mobile. Some embodiments may be implemented as a browser-based system that is accessible from the internet. From a macro-perspective, embodiments may provide access to content based on a user's need. As such, embodiments may be built within a Content Management System (CMS). Given the potential dynamic nature of some content, a backend database may be necessary to manage some of the content. Functionality from a user perspective may be derived specifically from a content/task analysis. The results from use cases may delineate certain features that would support a user community. These include, but are not limited to: the capability to print, save, search, and share content; create a personal space of notes, personally rated content; upload content; navigate across components based on a selected technology; access support features such as Help and Dictionary; or the like.

Based on some functionality and discussions with stakeholders and information technology specialists, the framework for one embodiment may be developed in WordPress, an open-source blog publishing application or CMS powered by an open-source server-side scripting language known as Hypertext Preprocessor (PHP) and by MySQL—a relational database management system that may also be used for content management. It has many features including a plug-in architecture and a variety of supporting, function-oriented templates. A design template for an embodiment may be created using branding guidelines which may be used throughout an embodiment to maintain a consistent look and feel.

Navigation as per some embodiments may address some use cases such as, but not limited to: a user who is not familiar with what technology can do in a teaching and learning context and wants to learn about technology (i.e. an embodiment of a Explore Research component); a user who has a known learning outcome and wants to see what technologies might be beneficial for that instance (i.e. an embodiment of a Select Best Technology component); a user who wants to see how to apply a technology and practice those steps (i.e. an embodiment of a Apply Technology component); a user has been directed to use a particular technology and wants to learn all about what the research says about the technology and how to apply it (i.e. an embodiment of a Technology quick links); or the like

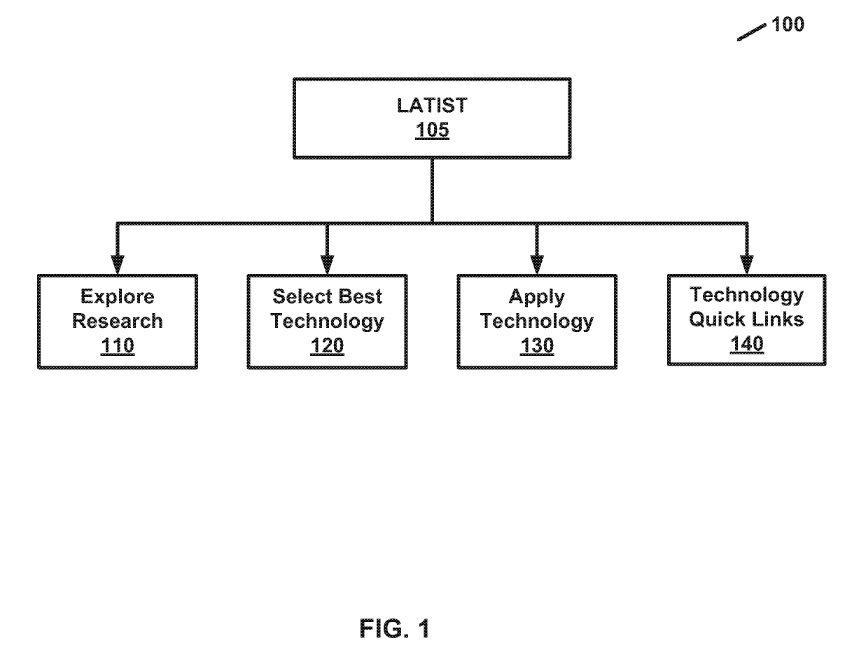

As such, the navigation from LATIST 105 indicated in example FIG. 1 may support a use case approach, that is, Explore Research 110, Select Best Technology 120, and Apply Technology 130. Additionally, the navigation may support the ability to drill down to resources related to a particular technology using the Technology quick links option 140. In this case, the technologies may be presented in alphabetical order. However, in the Explore Research 110 and the Apply Technology 130, the available technologies may be categorized as Social Media, Mobile Technology, Virtual Worlds/Games and Simulations, or the like. This presentation by categories illustrated in this example may help the user understand the differences in the technologies.

Embodiments of LATIST may be implemented as a performance support tool housed in a CMS. According to embodiments, an initial page may be used by a user to choose to enter the Explore Research 110, Select Best Technology 120, or Apply Technology components 130. Additionally, from the LATIST home page 105, users may have the ability to select a technology and receive a list of all information pages from the Explore Research 110 and Apply Technology components 130 for the selected technology (Technology quick links 140). The following outlines site content for an embodiment of LATIST. One skilled in the art will recognize that other content may be used in alternative embodiments of the present invention. The specific content in the outline may remain scalable to allow for new technologies to be added as they emerge.

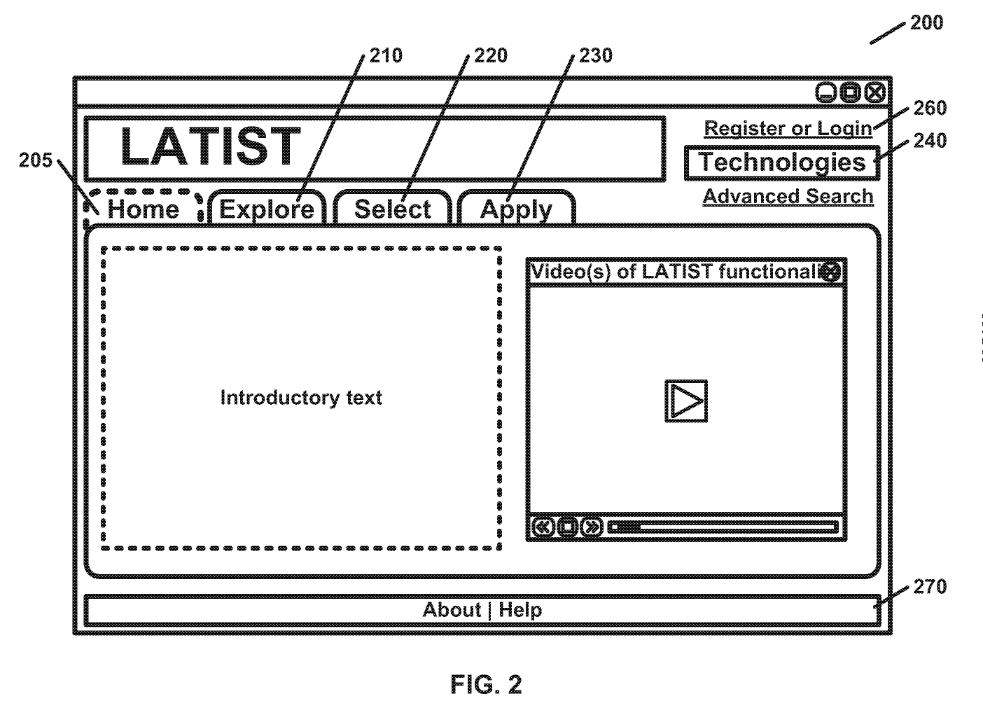

FIG. 2 is an illustration of an example home page as per an aspect of an embodiment of the present invention. Login-Access 260 features may include, but are not limited to: mark as favorite, upload content, take notes into personal space, or the like. Other links 270 may include, but are not limited to: About this project, Help, Dictionary, or the like. Technologies quick links 240 may provide access to Explore Research and Apply Technology content for a selected technology. Explore Research Home tab 210 may link to a page used to select technology for Overview, Advantages, Disadvantages, Best Practices, Literature, or the like. Select Best Technology tab 220 may link to a page for providing access to: Decision Aide View generated report, Factors Grid View generated report, or the like. Apply Technology tab 230 may link to a page for selecting technology for tutorial and practice.

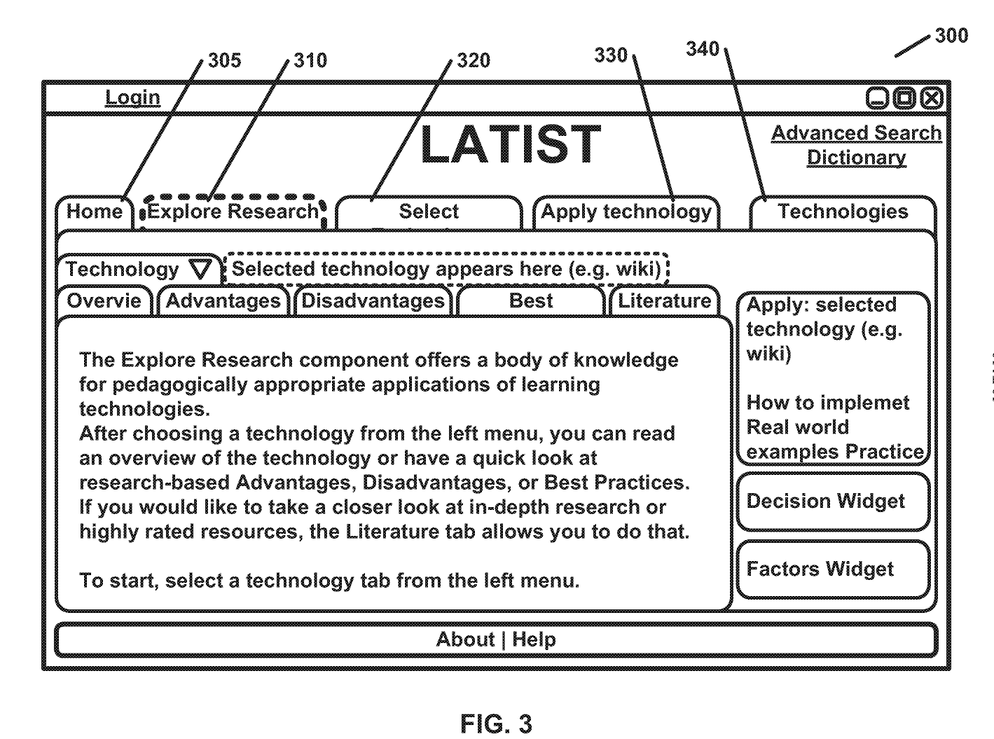

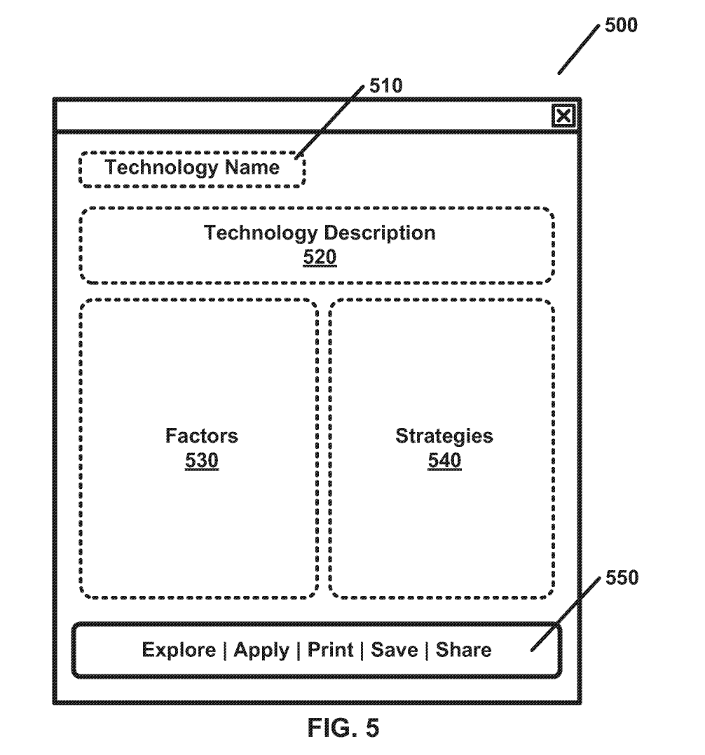

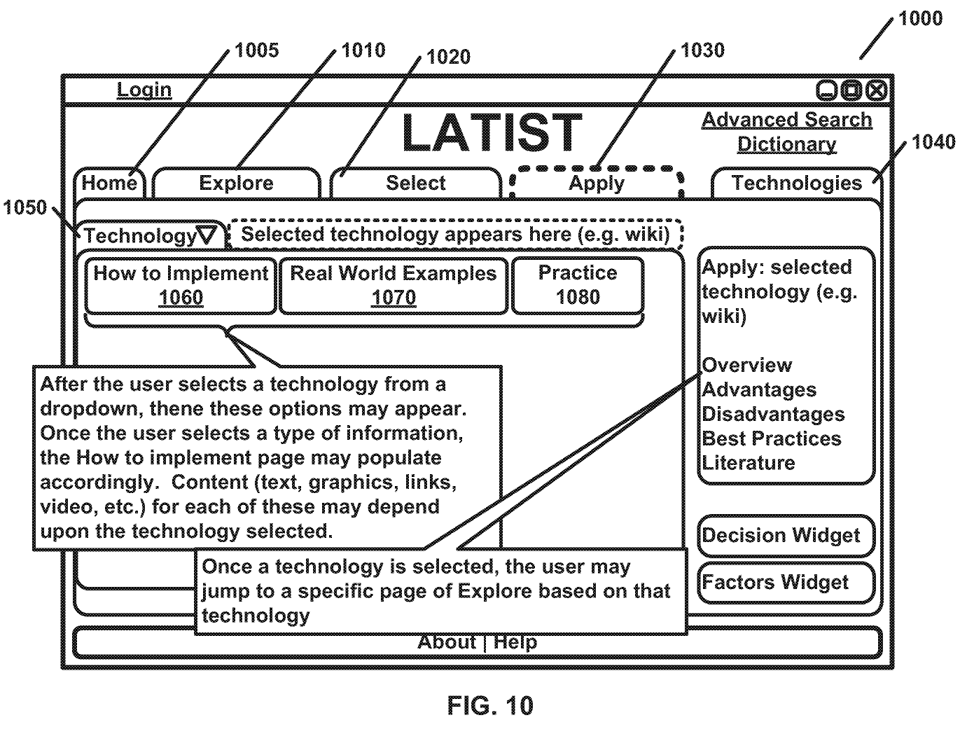

A global wireframe for embodiments may be developed based on the desired content while remaining cognizant that the embodiment is a performance support tool and not just a website. The global wireframe, as seen from the home page, may provide the developer with a graphical representation of the current vision for supporting the flowchart 100 and content. The initial homepage wireframe depicted in FIG. 2 and the final wireframe may not necessarily reflect the best design for the user and may be open to changes or recommendations provided by developer(s). Based on the system and user requirements, wireframes may be developed for the Explore Research home page (FIG. 3), Select Best Technology home page (FIG. 5), Apply Technology home page (FIG. 10), and the Technology quick links functionality. Additionally, wireframes may be developed for the user login and an Advanced Search to reflect envisioned functionality and capability associated with each of these features.

Embodiments of LATIST may require a backend database to maintain data element relationships. The Select Best Technology 220 may use a database to support the dynamic selection of a technology based on learning objective or other specific factors. The Explore Research 210 and Apply Technology components 230 may share a database to categorize and track resources associated with these components such as videos and research papers. The Explore Research and Apply Technology database may support features such as Advanced Search and resource rating. The following provides the information to support development of these databases. The database relationships are not indicative of navigation.

Embodiments of the Select Best Technology component may used to assist users in making decisions when implementing technology into their learning assets. The Select Best Technology component may include a Decision Aide and/or Factors Grid, or the like. Embodiments of the Decision Aide may start with a user identifying the level of their learning objective based on a taxonomy such as Bloom's taxonomy. Decision Aide embodiments may generate instructional strategies from which a user may select one that interests them. Based on these sequenced selections, the Decision Aide may generate a list of recommended technologies to consider as well as a description on how that technology may support the corresponding instructional strategy.

According to embodiments of the Factors Grid, factors may be ordered factors that influence the selection, usage, and integration of technology into their learning assets. Based on discussions with stakeholders, some factors may be considered paramount and may be used in embodiments. Stakeholders may provide bounding parameters associated with each factor.

According to embodiments of the Factors Grid, entity relationships may be defined in which factor(s) may relate to technology types. Similarly, technolog(ies) may relate to factor(s). Each of the factors may need a field for a description. Each of these parameters and factor categories may need to be updatable (the technologies in the development and maintenance cost categories are placeholders)

Embodiments of Explore Research and Apply Technology components may use a database to organize resources so they are searchable and can be personalized, such as by marking as a favorite. User(s) may be able to personalize resource(s) by: annotating it as their favorite, rating it, and adding notes associated with each resource (separate from the resource), or the like. The user may also be able to take notes not associated with a particular resource.

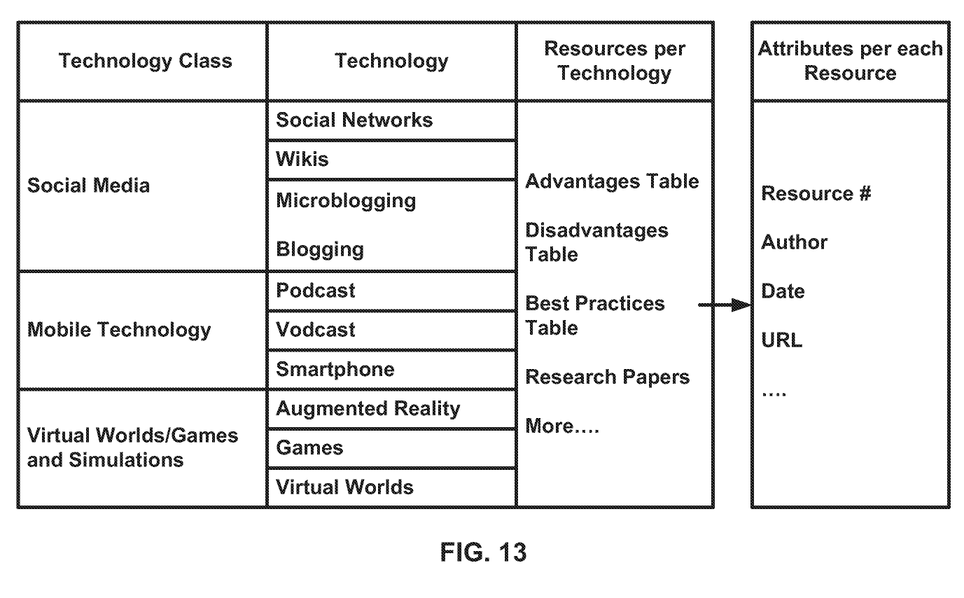

FIG. 13 is an example resource attributes table as per an aspect of an embodiment of the present invention. The types of resources could be word documents, pdf, html, video, audio files or the like. Resource(s) may be associated with a technology class and a technology. Technology classes include, but are not limited to: social media, mobile technology, virtual worlds/games, simulations or the like. Examples of technologies are: social networks, wikis, microblogging, blogging, podcast, vodcast, smartphone, augmented reality, games, virtual worlds or the like. Each resource may be identified by several attributes as indicated in the table below. Some resources may not have all database elements populated, such as an internally developed podcast may not have an author or date but will have a title, keywords, rating, file name, file type.

Resources may contain data such as: Technology Categories; Technologies; Date, Title, Keywords, Citation, Rating, URL, File name, File type, Date Uploaded, Resource type, or the like.

Examples of Technology Categories include, but are not limited to: Social Media, Mobile Technology, Virtual Worlds/Games and Simulations, or the like. Examples of Technologies include, but are not limited to: social networks, wikis, microblogging, blogging, podcast, vodcast, smartphone, augmented reality, games, virtual worlds or the like. Author attributes may be defined as, for example: Last name of first author, if more than one author, add et al (e.g. Mimirinis et al.). The Date may identify when a resource was published. The Title may include a full or partial title of a resource. Keywords or tags may include open entries, such as Twitter, case history, military, etc. Citation may identify the source of a reference according to an established citation format such as a full APA style citation. Ratings may be in numerous forms such as a numeric rating (e.g. 1-4), an average rating from users, or the like. A URL category may provide a link to documents external to LATIST (opens in a new window). A File name category may identify the filename and/or location of media files housed internal to LATIST (audio, video, documents, etc). The File type category may indicate to user what file type they are accessing. The Date Uploaded category may indicate the date when the resource was uploaded to LATIST. The Resource type category may indicate the type of resource containing the information such as a book, journal, research, white paper, or the like.

Embodiments may support an Amazon-style recommended reading based tracking the resource selection of users to produce the recommended reading. Recommended reading might say something similar to: ‘others who have reviewed this, have also reviewed this . . . . ’ Embodiments may also include an RSS that notifies users to resources uploaded to LATIST.

Embodiments may be implemented utilizing a WordPress platform with MySQL as the database. Also, embodiments may be implemented to effectively work with browsers such as Internet Explorer, Firefox, Chrome or the like. Embodiments may be implemented to be used with mobile devices. According to embodiments, multiple navigation points may be supported so that users may navigate and search by component or by technology.

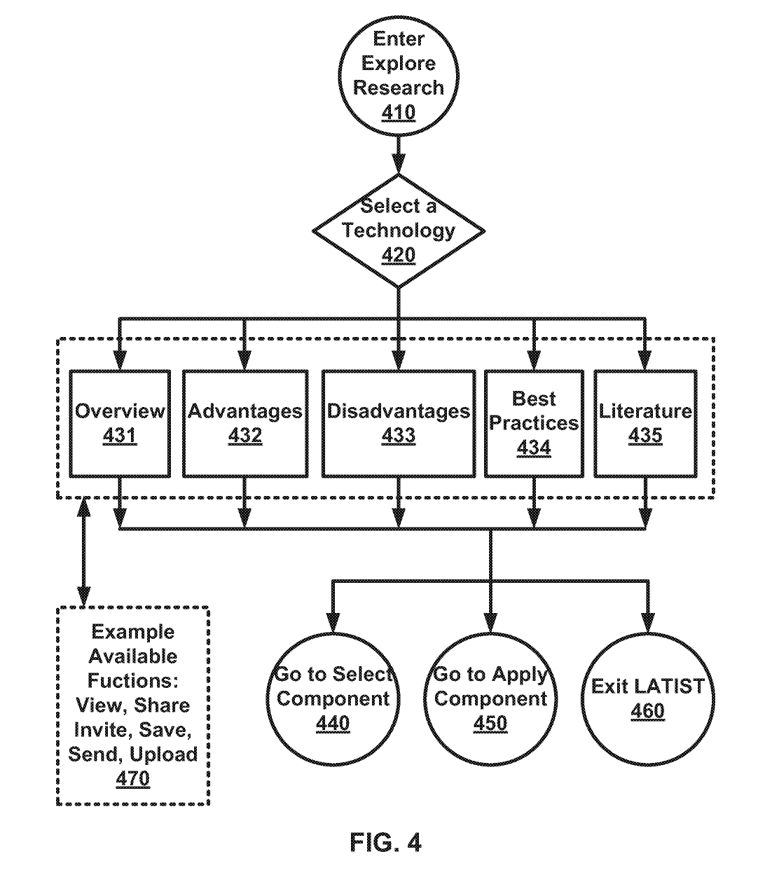

FIG. 4 is flow diagram of an embodiment of an explore research component as per an aspect of an embodiment of the present invention. The primary navigation for LATIST may be by component (Explore Research, Select Best Technology, Apply Technology) while a secondary navigation by technology may be supported (Technology quick links). Entering Explore Research 410 from a navigation source, the user may select a technology to research 420. Once a technology is selected, the user may be presented with an overview 431 of that technology. The user will be able to select to review advantages 432, disadvantages 433, best practices 434, and literature 435 on that technology. After the user has selected a technology and reviewed the provided research-based information, the user can move to another component 440 based on that technology. For example the user can navigate to the Apply Technology component 450 (tutorial or practice) with the technology already selected, or Exit 460 the tool.

While in the Explore Research component, the user may be able to navigate to other Explore Research subcomponent(s) or the Select Best Technology component or the Apply Technology component or exit LATIST. The user may be able to add, upload, search, take notes, rate resources, mark as favorite, print, and subscribe/receive RSS feeds, and print 470. Modifications to LATIST content may require user login.

Example functionalities as per some of the various embodiments include, but are not limited to: Add function, Search function, Upload function, Rate function, Mark as Favorite function, Review Favorites function, Print function, RSS Feeds function, Save function, Recommended Reading function, or the like. According to embodiments, the Add function may allow user(s) to add content to the advantages, disadvantages, and best practices tables. According to embodiments, the Search function may allow user(s) to search for resources across LATIST by author, date, title, technology, sub-technology, keyword, rating, and marked as personal favorites. According to embodiments, search results may include, but are not limited to: the author, date, title, average rating, access the full citation, link to the resource, link to the user's personal notes associated with the resource, if the user has previously marked the resource as a favorite or the like. The user may be able to sort search results by author, date, and rating. Note that not all fields may be populated for all resources. The user may be able to view/read selected resource in its native format (pdf, excel, wmv, etc). According to embodiments, the Upload function may allow user(s) to upload resources and provide database elements (author, date, title, author, rate, file name; see data element model). Add a check box reflecting user has reviewed copyright permission. Notes: The user may be able to create personal notes for each resource and as independent files. The notes may be edited, saved, and printed. According to embodiments, the Rate function may allow user(s) to enter a rating for any resource; an average for all users may be displayed visually with an iconic rating such as 1-4. According to embodiments, the Mark as Favorite function may allow user(s) to mark as favorite any resource from the search results list. According to embodiments, the Review Favorites function may allow user(s) to view their list of personal favorites. The list may be presented similar to the search results and with the same functionality. According to embodiments, the Print function may allow user(s) to print resources in its native format and print screen in printer friendly format, such as the results from the search function. According to embodiments, the RSS Feeds function may allow user(s) to subscribe to and receive RSS feeds. An RSS may be implemented that notifies users to resources uploaded to LATIST. According to embodiments, the Save function may allow user(s) to save selected resources to a user specified location. According to embodiments, the Recommended Reading function may allow user(s) to view a recommended reading list based on prior resource selection.

FIG. 5 is an illustration of an example technology report as per an aspect of an embodiment of the present invention. Through both the Decision Aide and the Factors Grid, users may be able to generate a report 500 about a specific technology 510. This report may include, but is not limited to: short descriptions of technology 520; list of strategies 540 supported by the technology; factors 530 mapped to technology; links 550 to technology sections of Explore Research and Apply Technology components; links to print, save, and share; or the like. According to some embodiments, user(s) may be able to print the report in a print-friendly format. According to embodiments, user(s) may be able to save the report to a user specified location. According to embodiments, user(s) may be able to share the report through email. According to embodiments, user(s) may be able to browse information in the factors matrix by technology or by factor. According to embodiments, user(s) may be able to navigate to the other components of LATIST that are related to a specific technology.

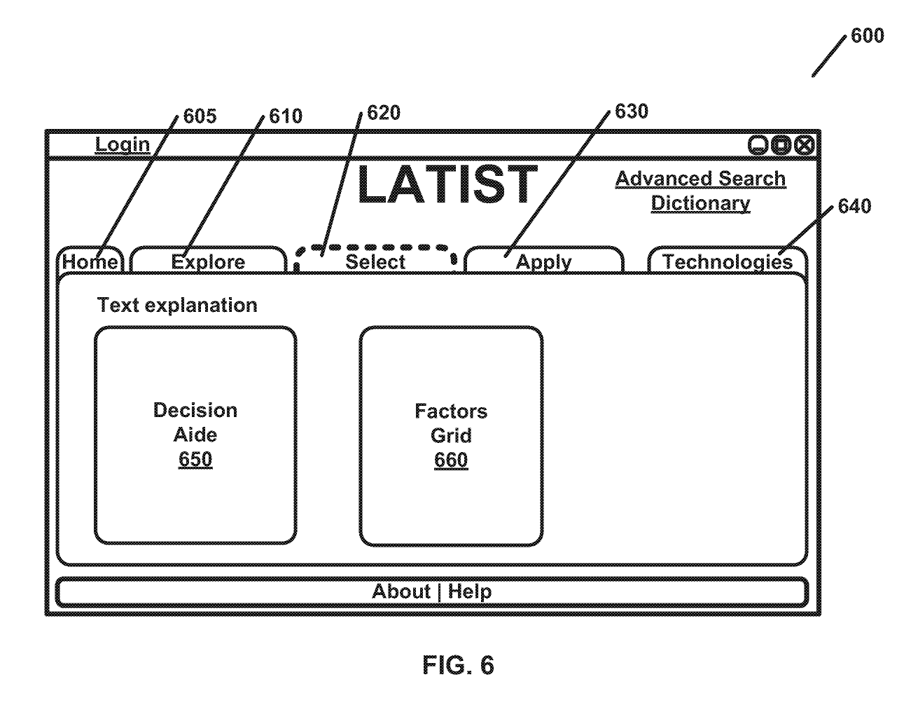

FIG. 6 is an illustration of an example Select Technology home page as per an aspect of an embodiment of the present invention. According to some embodiments, a home navigation tab 605 links to a LATIST home page, an Explore Technologies tab 610 links to an explore technologies home page, an Apply Technologies tab 630 links to an Apply technologies home page and a technologies navigation tab 640 links to technolog(ies). A select technologies tab 620 may indicate through a visual differentiation that this tab is currently selected. The navigation tabs indicate one mechanism for linking to other functionality within embodiments of LATIST. However, one skilled in the art will recognize that other methods of navigation may be used such as a link, a control panel, or the like. According to some embodiments, a decision aide 650 may be entered from this page. According to some embodiments, a factors grid 660 may be entered from this page. Some embodiments may include either the decision aide 650 alone, the factors grid 660 alone, both the decision aide 650 and the factors grid 660, or the like

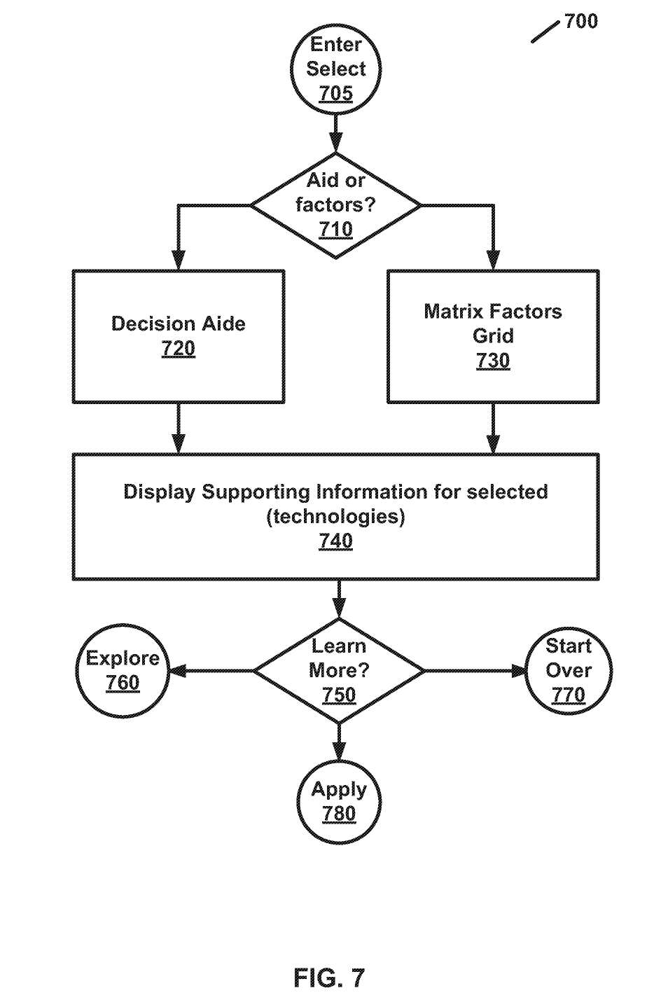

FIG. 7 is an example flow diagram 700 of a Select Technology component as per an aspect of an embodiment of the present invention. According to some embodiments the Select Technology component can be entered at 705. At 706, a decision may be made to enter the decision aide 710 or the Factors grid 720. At 740, supporting information may be displayed for selected technolog(ies). At 750, the user may select between navigating to Explore technologies at 760, Select technologies at 770, Apply technology at 780, or the like.

Embodiments of the present invention may be implemented as a non-transitory tangible computer readable medium containing computer readable instructions for causing one or more processors to perform a process for making a pedagogically informed selection of a learning technology.

At 810, predetermined learning outcomes taxonomy level(s) for learning objective(s) may be presented to users(s). An examples of “learning outcomes taxonom(ies) are: a Bloom's taxonomy, Bloom's taxonomy, Revised Bloom's taxonomy, Merrill's taxonomy, Jonassen and Tessmer's taxonomy, Krathwol's taxonomy, Harrow's taxonomy, Gagne taxonomy, Revised Gagne taxonomy or the like. Examples of learning objective(s) in some embodiments may include: a remembering and understanding objective, an applying and analyzing objective, and an evaluating and creating objective. Examples of learning objective(s) in other embodiments may include: a remembering objective, an understanding objective, an applying objective, an analyzing objective, an evaluating objective, a creating objective, a combination of adjacent elements of the above or the like.

Predetermined instructional strategy(ies) aligned with a selected learning outcomes taxonomy level(s) chosen from the predetermined learning outcomes taxonomy level(s) may be presented to the user(s) at 820. Examples of predetermined instructional strategy(ies) aligned with the “remembering and understanding” taxonomy level, but are not limited to include: presentation(s), lecture(s), questioning, examples, practice, elaboration, rehearsal, a combination of the above or the like. Examples of predetermined instructional strategy(ies) aligned with the “applying and analyzing” taxonomy level include, but are not limited to: role playing, articulation, advance organizers, feedbacks, compare and contrast, worked examples, combinations of the above or the like. Examples of predetermined instructional strategy(ies) aligned with the “evaluating and creating” learning level includes, but is not limited to: problem solving, hypothesis generation, reflection, case stud(ies), collaboration, authentic task(s), combination(s) of the above or the like.

At 830, predetermined learning technolog(ies) chosen from the predetermined instructional strategy(ies) are presented to the user(s). Examples of predetermined learning technolog(ies) include, but are not limited to: an augmented reality technolog(ies), blog(s), game(s), microblog(s), podcast(s), social network(s), virtual world(s), vodcast(s), wiki(s), combination(s) of the above or the like. It is anticipated that several of the technologies may be implemented in various ways. For example, games may be implemented as educational games, casual games, serious games, multi-player games, role-playing games.

The term predetermined in this specification refers to filtered selections resulting from pedagogically informed research. For example, at least some of the following may be selected from pedagogically informed research: predetermined learning outcomes taxonomy level(s), predetermined instructional strategy(ies), predetermined learning technolog(ies) or the like.

Additionally, according to some embodiments, learning technology constraint(s) may be presented to the user as shown in 840. These constraint(s) may be shown in a factors grid. The predetermined learning technolog(ies) presented to the user may also satisfy all or part of selected learning technology constraint(s). Examples of learning technology constraint(s) may include, but are not limited to: content stability, connectivity, development cost, maintenance cost, speed to market, a combination of the above or the like.

According to some embodiments may enable user(s) to explore predetermined learning technolog(ies) 850. The exploring capability may include presenting knowledge about the predetermined learning technolog(ies). Knowledge may include information about learning technolog(ies) such as overview(s), advantage(s), disadvantage(s), best practice(s), literature, combination(s) of the above or the like.

Some embodiments may include a capability to apply selected predetermined learning technolog(ies) 860. For example, embodiments may include presenting information about the selected predetermined learning technolog(ies) such as how to implement the technolog(ies), real world examples of the technolog(ies) in use, an ability to practice using the technolog(ies), a combination of the above or the like.

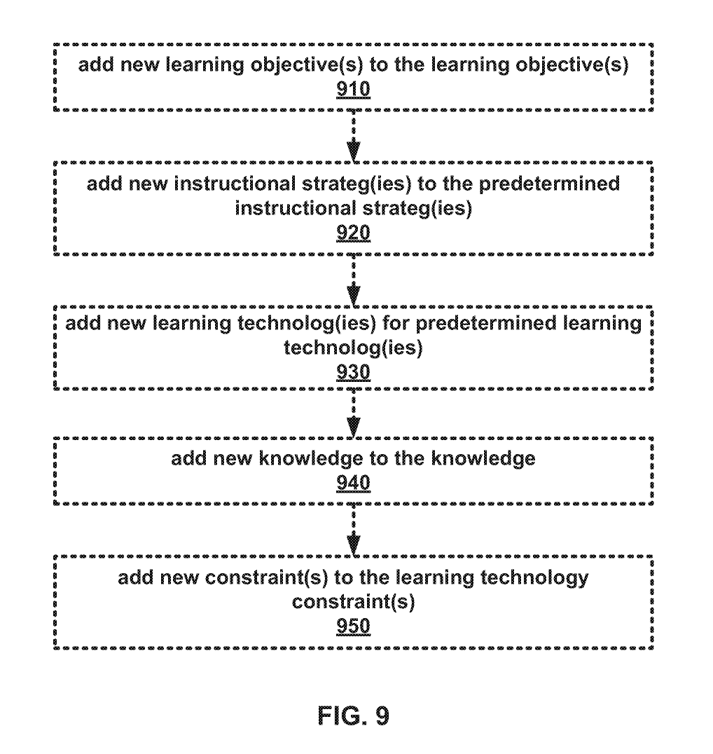

FIG. 9 is an example flow diagram illustrating the addition of materials to LATIST as per an aspect of an embodiment of the present invention. According to some embodiments, user(s), instructional technologist(s) or the like may add materials to presentable options. For example, new learning objective(s) may be added to the learning objective(s) 910, new instructional strategy(ies) may be added to the predetermined instructional strategy(ies) 920, new learning technolog(ies) may be added to the predetermined learning technolog(ies) 930, new knowledge may be added to the “knowledge” 940, new constraint(s) may be added to the learning technology constraint(s) 950, or the like. This capability may enable the filtering and classification of materials presented to user(s) to achieve making a pedagogically informed selection of a learning technology for a learning objective.

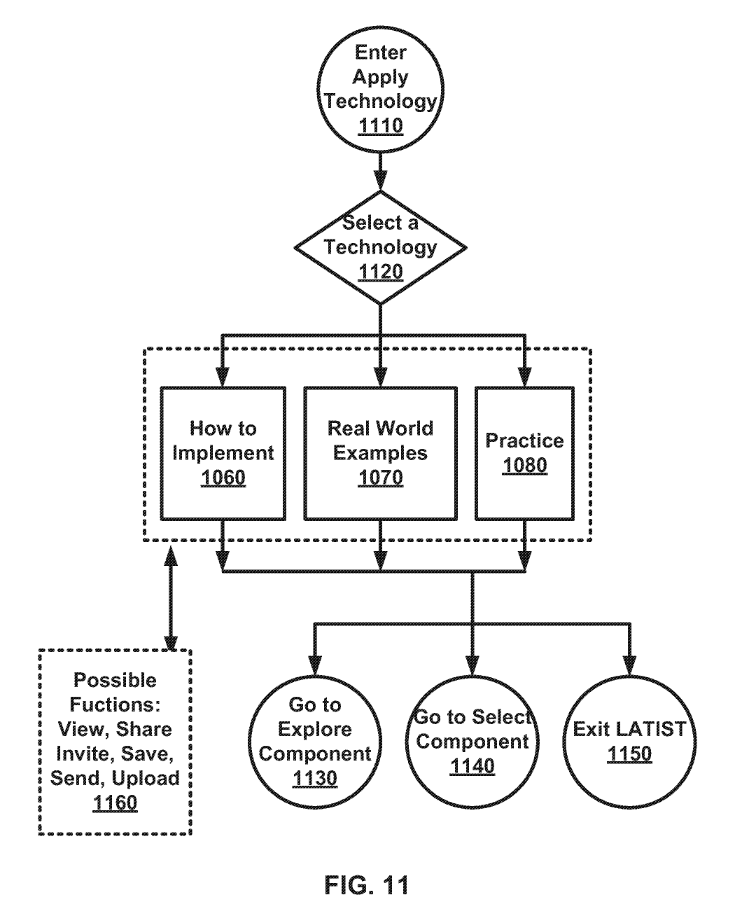

FIG. 10 is an illustration of an example Select Technology home page 1000 as per an aspect of an embodiment of the present invention and FIG. 11 is an example flow diagram of an Apply Technology component as per an aspect of an embodiment of the present invention.

The primary navigation for LATIST may be by component (Explore Research 1005, Select Best Technology 1020, Apply Technology 1030) while a secondary navigation by technology 1040 may be supported (and/or Technology quick links 1050). User(s) may entering Apply technology 1110 from the primary navigation using tab 1030. Navigation within the example Apply Technology component may be by the technology classes: 1) Social Media, 2) Mobile Technology, and 3) Virtual Worlds/Games and Simulation. Each technology class may have specific technologies listed within that category.

Technolog(ies) may have some the following functions: a How to implement 1060; Real World Examples 1070; Practice 1080; or the like.

How to implement subcomponent 1060: In this area, the user could read, view or link to an explanation of how to implement a specific technology contextualized to content. The subcomponent may contain Flash/video/text/text document/URL files as required to access the how to develop explanation.

Real world examples subcomponent 1070: In this area, the user may be provided with a URL to an external website which will allow them to get an opportunity to see how a specific technology is being used in a real world context as well as contextualized to DAU content.

Practice subcomponent 1080: This area may provide the user a URL to an external website which may allow them to get an opportunity to experiment using a specific technology.

While in the Apply Technology component, the user may navigate to other Apply subcomponents or the Select Best Technology component 1140 or the Explore Research component 1130 or exit LATIST at 1150. The user may be able to add, upload, search, print, send, and login. Modification to LATIST content may require user login.

Possible functionalities 1160 of some of the various embodiments include: Add, Search, Upload, Print, Save, Navigate, Send, Open Content, and Login. According to embodiments, the Add function may allow user(s) to add content to any of the subcomponents within the Apply Technology component. According to embodiments, the Search function may allow user(s) to search for resources across LATIST by author, date, title, technology, sub-technology, keyword, rating, and marked as personal favorites. According to embodiments, the Upload function may allow user(s) to upload resources and provide database elements (author, date, title, author, rate, file name; see data element model). According to embodiments, the Print function may allow user(s) to print resources in its native format and print screen in printer friendly format, such as the results from the search function. According to embodiments, the Save function may allow user(s) to save selected resources to a user specified location, in any specified format and file type. According to embodiments, the Navigate function may allow user(s) to navigate anywhere within LATIST within 3 clicks or less; users shall be able to seamlessly navigate to subcomponents within the Apply Technology component as well as to related content within other components/subcomponents. According to embodiments, the Send function may allow user(s) to send from the Apply Technology component. Users May need the ability to send media files, emails, and links to pages and print friendly versions of text from the Apply Technology component. According to embodiments, the Open Content function may allow user(s) to open content in the Apply Technology component. Users may be able to open content using double right clicks in standard windows format with the option of opening material in a separate window. According to embodiments, the Login function may allow user(s) to login prior to adding or uploading content into the Apply. Users may be able to login using an ID and password, through creating an ID and password for the first time, and may be able to access all secure elements of LATIST once logged in.

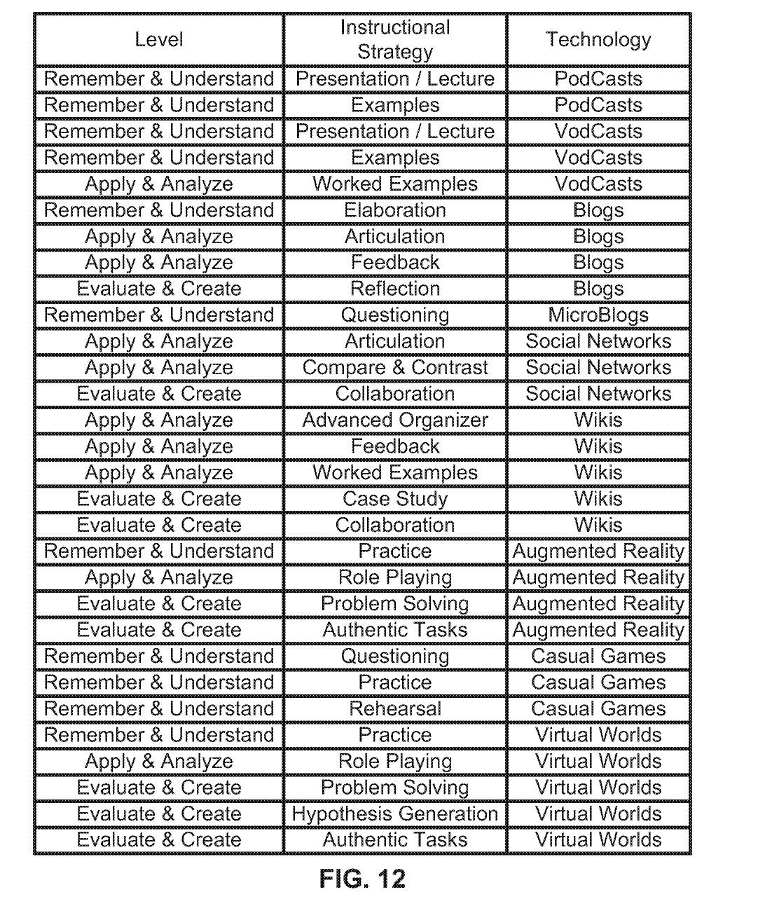

FIG. 12 is a table showing example relationships between Bloom's learning level to instructional strategy to technology. Instructional strategies include, but are not limited to: Presentation/Lecture, Practice, Problem Solving, Role Playing, Articulation, Hypothesis Generation, Reflection, Case Study, Collaboration, Advance Organizers, Feedback, Authentic Tasks, Elaboration, Rehearsal, Compare and Contrast, Worked Example, or the like. Presentation/Lecture is an instructional strategy involving a one-way method of conveying information to an audience or class, especially for instruction or to set forth a subject matter. Questioning is an instructional strategy where the instructor may ask questions or encourages students to ask questions with the intent to focus students on what is central and most important for learning. Examples is an instructional strategy where representative samples are used that illustrate instances of a concept or procedure.

Practice is an instructional strategy that involves performing repeatedly to facilitate recall, long term retention, and skill building. Problem Solving is an instructional strategy involving activities that place more emphasis on learning how to learn such as learning how to form a hypothesis, find and sort information, think critically about information, ask questions, and reach a resolution or solution.

Role Playing is an instructional strategy that involves activities that allow students to assume practitioner and professional roles such as scientists, physicians, historians and act out situations that these professionals face in the real world. Articulation is an instructional strategy that involves students making tacit knowledge explicit by explaining to others what they know, resulting in shared perspectives to generalize their knowledge to different contexts. Hypothesis Generation is an instructional strategy where students acquire concepts by setting forth tentative hypotheses, educated guesses, or expectations about the attributes that seem to define a concept, then testing specific instances against these hypotheses.

Reflection is an instructional strategy that involves students reviewing what they have done, analyzing their performance, and comparing it to that of experts and peers. Case Study is an instructional strategy that presents real-world problems or situations to students for problem solving. Collaboration is an instructional strategy where students share different viewpoints and ideas, jointly solve problems, and build knowledge through group activity. Advance Organizers is an instructional strategy involving students generating logical relationships among the elements in the to-be-learned information. Feedback is an instructional strategy where instructors or peers offer informative critique on the student's performance aimed at showing how to improve a current skill or detect and correct a misconception or error.

Authentic Tasks is an instructional strategy that involves activities intended to provide real-world, meaningful, relevant, novel, and complex situations to promote student interest, engagement, and problem solving. Elaboration is an instructional strategy that involves active learner participation to integrate new material with existing knowledge, such as paraphrasing, summarizing, creating analogies, and note taking. Rehearsal is an instructional strategy that involves basic memory tasks such as reciting items or verbalizing and visualizing the material to be learned through underlining, highlighting, defining, listing, discriminating. Compare and Contrast is an instructional strategy that examines significant similarities and differences between potentially confusable ideas in order to increase the discriminability of those ideas. Worked Example is an instructional strategy involving a step-by-step demonstration of how to perform a task or solve a problem.

Technologies include. but are not limited to: Podcasts, Vodcasts, Blogs, Microblogs, Social networks, Wikis, Augmented Reality (AR), Casual games, Virtual worlds, or the like.

Podcasts is a term derived from a combination of two separate words, pod derived from iPod and cast from broadcasting. Podcasts are defined as an audio media file available for download from the internet or to subscribers through a syndication feed which can be played at a later point in time on any device capable of playing MP3 files. Using podcasts may be an inexpensive way to create audio files for instruction. In higher education, instructors typically provide podcasts of recorded lectures or supplementary course content materials. Learners cite portability and flexibility as benefits of podcasts. A high degree of learner satisfaction is associated with the use of podcasts. Podcasts facilitate learning-on-the-go and may be used to disseminate language lessons, recorded lectures, and supplemental course material.

Vodcasts, also called video podcasts or vlogging, add video to the downloadable sound files familiar to podcast listeners. Vodcasts deliver Video On Demand (VOD) files online via syndication which can be played at a later time. A digital player with video capabilities may be needed to view vodcasts. A vodcast may be an efficient, appealing way to create digital content for instruction. It has been used by education institutions at all levels. Vodcasts support a variety of learning styles and offer students the flexibility to view information anywhere, any time.

Blogs (or weblogs) are an online, chronological collection of personal commentary that serves to capture thoughts and comments on a website for others to read. Entries can include text, hyperlinks, images, or multimedia, and visitors can read postings, submit comments, and search the site by date or keyword. Blogs may be used to create asynchronous discussion forums, which are particularly beneficial for distance learning and hybrid courses. Proponents of blogs contend that blogs promote conversational interactivity, increase creative responses from students, and connect learners beyond the classroom. Blogs may give students an audience for their writing, encouraging thoughtfulness and clarity and enabling learning through online debate, peer.

Microblogs are blogs that are restricted to 140 characters per post and can be sent or ‘tweeted” to multiple readers on various devices. Once a microblog is posted, the message becomes instantaneously available to other users who are “following” that user. Microblogs may be optimized for social connections, allow for continued conversation outside the classroom, and provide an easy way to update students on course logistics.

Social networks allow users to set up profiles or homepages from which their network of “friends” or people with shared interests and goals can view posted information. User profiles often contain diverse content ranging from demographic data such as gender to personal favorites such as music or books. Users may modify the appearance of their pages and add text and media content to reflect their personalities, interests, and goals. Organizations and education institutions use social networks to facilitate knowledge sharing and foster learning communities.

Wikis are editable websites often used for collaboration between group members by providing a shared workspace. Wikis may be public or private, with individual privileges assigned to add, edit, and delete content. Many wikis are fully customizable, meaning that one can change the structure and text, pictures or other content formats. A web browser is the only requirement needed to work in a wiki, which means no programming skills are required. Wikis support collaboration, case studies, and critical thinking, and encourage student participation as well as enhance student motivation. Wikis may allow students to work together to build knowledge bases, synthesize research, write papers, and present projects.

Augmented Reality (AR) is when virtual data such as text, pictures, or video is combined with what we see in the real world. When American football is televised, the virtual line seen by viewers indicating the distance of the ball from the goal is a basic AR application. Special software registers and aligns virtual, visual overlays that can then be viewed using hardware such as a television, PDA or smartphone. AR is effective for learning procedural tasks such as in manufacturing and medicine as well as for providing digital information for simulations and investigations.

Casual games include simple digital games, typically short in duration and do not require any special skills Casual games are structured activities with simple rules and goals. Casual games must be easy to understand, interesting, and focused on important learning content. Casual games can be played on a computer, in a browser, or on a smart phone, and include puzzles, word games, hidden object games, and strategy games.

Virtual worlds provide a 3D persistent immersive place to socialize, collaborate, create, and communicate with a sense of presence and awareness of one's surroundings. As a learning environment, it allows manipulation of both time and space; slowing or speeding time such as in simulations; viewing microscopic as macroscopic and vice versa; implementation of exploratory and experiential learning; and asynchronous and synchronous distance learning.

In this specification, “a” and “an” and similar phrases are to be interpreted as “at least one” and “one or more.” References to “an” embodiment in this disclosure are not necessarily to the same embodiment.

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, wetware (i.e hardware with a biological element) or a combination thereof, all of which are behaviorally equivalent. For example, modules may be implemented using computer hardware in combination with software routine(s) written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies may be used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) of selecting technologies for online learning. However, one skilled in the art will recognize that embodiments of the invention could be implemented to provide practicum learning, mentor based learning, tutor based learning, in class learning, administration of learning or the like.

In addition, it should be understood that any figures that highlight any functionality and/or advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A non-transitory tangible computer readable medium containing computer readable instructions that when executed by one or more processors causes the one or more processors to perform a process for making a pedagogically informed selection of a learning technology comprising:
a. presenting at least one predetermined learning outcomes taxonomy level for at least one learning objective;
b. presenting at least one predetermined instructional strategy aligned with a selected learning outcomes taxonomy level chosen from said at least one predetermined learning outcomes taxonomy level; and
c. presenting at least one predetermined learning technology chosen from said at least one predetermined instructional strategy; and
wherein at least one of the following is pedagogically informed:
a. said at least one predetermined learning outcomes taxonomy level;
b. said at least one predetermined instructional strategy; and
c. said at least one predetermined learning technology.

2. A medium according to claim 1, further including presenting at least one learning technology constraint.

3. A medium according to claim 2, wherein said at least one predetermined learning technology satisfies at least one of said at least one learning technology constraint.

4. A medium according to claim 2, wherein said at least one learning technology constraint includes at least one of the following:
a. content stability;
b. connectivity;
c. development cost;
d. maintenance cost;
e. speed to market; or
f. a combination of the above.

5. A medium according to claim 1, further including exploring at least one of said at least one predetermined learning technology.

6. A medium according to claim 5, wherein said exploring includes presenting knowledge about at least one of said at least one predetermined learning technology.

7. A medium according to claim 6, wherein said knowledge includes at least one of the following:
a. an overview;
b. an advantage;
c. a disadvantage;
d. a best practice;
e. literature; or
f. a combination of the above.

8. A medium according to claim 1, further including applying at least one of said at least one predetermined learning technology.

9. A medium according to claim 8, wherein said applying includes presenting at least one of the following about at least one of said at least one predetermined learning technology:
a. how to implement;
b. real world examples;
c. practice; or
d. a combination of the above.

10. A medium according to claim 1, wherein at least one of said at least one learning objective includes at least one of the following types of objectives:
a. a remembering and understanding objective;
b. an applying and analyzing objective; and
c. an evaluating and creating objective.

11. A medium according to claim 1, wherein at least one of said at least one learning objective includes at least one of the following types of objectives:
a. a remembering objective;
b. an understanding objective;
c. an applying objective;
d. an analyzing objective;
e. an evaluating objective;
f. a creating objective; or
g. a combination of adjacent elements of the above

12. A medium according to claim 10, wherein at least one of said at least one predetermined instructional strategy aligned with said remembering and understanding level includes at least one of the following:
a. presentation;
b. lecture;
c. questioning;
d. examples;
e. practice;
f. elaboration;
g. rehearsal; or
h. a combination of the above.

13. A medium according to claim 10, wherein at least one of said at least one predetermined instructional strategy aligned with said applying and analyzing learning level includes at least one of the following:
a. role playing;
b. articulation;
c. advance organizers;
d. feedback;
e. compare and contrast;
f. worked examples; or
g. a combination of the above.

14. A medium according to claim 10, wherein at least one of said at least one predetermined instructional strategy aligned with said evaluating and creating learning level includes at least one of the following:
a. problem solving;
b. hypothesis generation;
c. reflection;
d. case study;
e. collaboration;
f. authentic tasks; or
g. a combination of the above.

15. A medium according to claim 1, wherein said learning outcomes taxonomy is a Bloom's taxonomy. (or revised)

16. A medium according to claim 1, wherein said learning outcomes taxonomy is one of the following:
a. Bloom's taxonomy;
b. Revised Bloom's taxonomy;
c. Merrill's taxonomy;
d. Jonassen and Tessmer's taxonomy;
e. Krathwol's taxonomy;
f. Harrow's taxonomy;
g. Gagne taxonomy; or
h. Revised Gagne taxonomy.

17. A medium according to claim 1, wherein at least one of said at least one predetermined learning technology is at least one of the following:
a. an augmented reality technology;
b. a blog;
c. a game; (educational, casual, serious, multi-player, role-playing . . . )
d. a microblog;
e. a podcast;
f. a social network;
g. a virtual world;
h. a vodcast;
i. a wiki; or
j. a combination of the above.

18. A medium according to claim 1, further including adding at least one new learning objective to said at least one learning objective.

19. A medium according to claim 1, further including adding at least one new instructional strategy to said at least one predetermined instructional strategy.

20. A medium according to claim 1, further including adding at least one new learning technology to at least one of said at least one predetermined learning technology.

21. A medium according to claim 6, further including adding new knowledge to said knowledge.

22. A medium according to claim 2, further including adding at least one new constraint to said at least one learning technology constraint.
